(19) United States
(12) Patent Application Publication
(10) Pub. No.: US 2022/0205428 A1
(43) Pub. Date: Jun. 30, 2022

(54) NOVEL WIND TURBINE AND ANCHORING SYSTEM THEREOF

(71) Applicant: NABRAWIND TECHNOLOGIES, SL., Pamplona (ES)

(72) Inventors: Ion AROCENA DE LA RÚA, Pamplona (ES); Eneko SANZ PASCUAL, Pamplona (ES)

(73) Assignee: NABRAWIND TECHNOLOGIES, SL., Pamplona (ES)

(21) Appl. No.: 17/543,994

(22) Filed: Dec. 7, 2021

(30) Foreign Application Priority Data
Dec. 28, 2020 (ES) 1276489

(51) Int. Cl. F03D 13/20; E02D 27/42; E02D 27/16

(52) U.S. Cl. CPC F03D 13/22; E02D 27/425; E02D 2300/0034; F05B 2240/912; E02D 2300/002; E02D 27/16

(57) ABSTRACT

A novel wind turbine, the tower of which ending with three legs and which is also anchored to the ground by means of a characteristic anchoring system depending on the type of existing soil. It is anchored on conventional rock soil with a pile foundation, it is anchored in a hard-rock soil with an anchor-rock foundation, it is anchored in a non-rocky soil with a gravitational foundation and it is anchored on clayey or swampy soil with a gravitational foundation reinforced with piles.

### CROSS-REFERENCE TO RELATED APPLICATIONS

This application claims the benefit of priority under 35 U.S.C. § 119 from Spain Patent Application No. 1276489, filed Dec. 28, 2020, incorporated herein by reference.

### FIELD OF INVENTION

The present invention falls within the wind turbine field, more specifically, in a novel wind turbine the tower of which ending with three legs and which is also anchored to the ground by means of a characteristic anchoring system depending on the type of existing soil.

### BACKGROUND

Ground-based wind turbines are anchored to the ground by means of a footing. As the height of the wind turbines increases, the size of the footing increases proportionally and consequently the amount of concrete used. The footings are made by making a circular hole in the ground, a reinforcement with metal bars is provided and concrete is poured until the entire hole is filled. On this base the wind turbine is set up, placing the tubular tower parts one on top of the other, to finally topping it off with the nacelle and the blades.

The works to make a footing are influenced by the type of soil. Establishing a reinforced concrete footing in a rocky area is more difficult than establishing it in a terrain with a lot of soil and little rock.

In order to use as little concrete as possible, it is presented the novel wind turbine constituting the inventive subject matter, using a specific and advantageous type of anchoring system for each type of soil.

### DESCRIPTION

Wind turbines consist of a tower, regardless of the type of tower used, anchored to the ground and supporting the nacelle, rotor and blades.

The proposed wind turbine has a tubular tower whose lower part is formed by a tripod. In this way, the base of the wind turbine has three legs and each leg has its corresponding anchoring system to the ground. If the diameter at the base of the tower of a conventional wind turbine is 4.5 m in the case of the novel wind turbine, the base is reduced to three legs of 1 m in diameter each. This reduces the amount of reinforced concrete used as footing.

Depending on the type of soil on which the wind turbine of the invention is to be established, a type of anchoring system is used:
Firstly, hardest floors. Rocky soils that have between 100 and 200 Megapascals. An anchored-in-rock foundation is used.
Secondly, rock soils of lower hardness, in which a pile foundation is used which requires less time and less quantity of concrete than conventional or gravitational foundations.
Thirdly, competent non-rocky soils, where a gravitational foundation is used.
And finally, poor soils and without consistency. They can be swampy or flooded terrain. A gravitational foundation with piles is used to provide stability.

The advantages are the savings of establishing a tower ending with three legs, which entails three anchoring systems compared to a single anchoring system used by conventional wind turbines. The volume of concrete for the footing of a 150 m tower height is 600 m³. The foundations presented herein reduce the amount of concrete required by more than 80%.

### BRIEF DESCRIPTION OF THE DRAWINGS

Below, it is very briefly described a series of drawings which will help us to better understand the invention and that expressly relate to an embodiment of said invention that is presented as a non-limiting example thereof.

FIG. 1 represents the entire wind turbine object of the invention.

FIG. 2 shows the anchoring system in rocky soils.

FIG. 3 shows the anchoring system by means of a pile foundation.

FIG. 4 shows the anchoring system by means a gravitational foundation.

FIG. 5 shows a last anchoring system by means of a gravitational foundation with piles.

### DETAILED DESCRIPTION

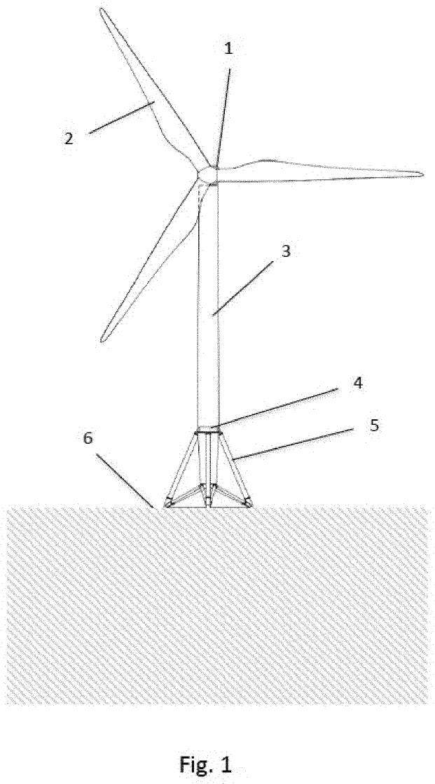

As shown in FIG. 1, the wind turbine of the invention consists of a nacelle with its corresponding rotor and blades and a tubular tower terminated in a transition piece, which has three legs and sits on the ground. The legs are spaced from each other at a distance much greater than their diameter, in the present embodiment they are 18 m from each other. The ratio between diameter and distance between legs is approximately one to twenty. Depending on the type of soil in question, the anchoring system of the legs will have some characteristics or others.

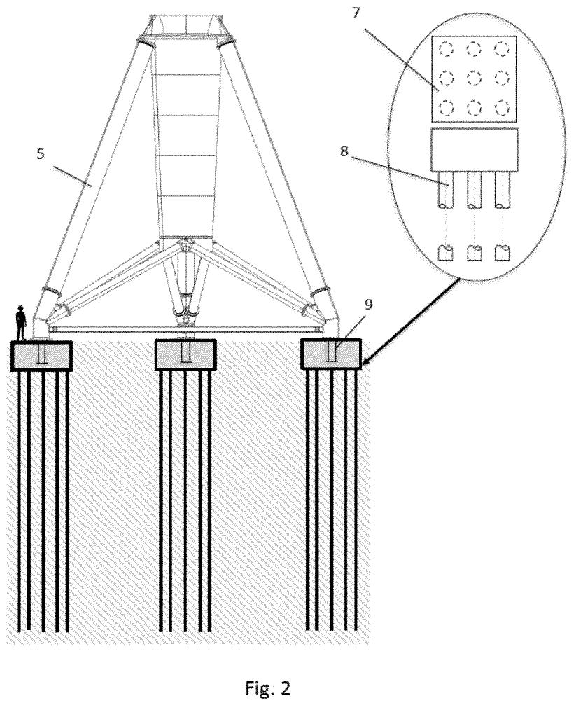

FIG. 2 shows the anchoring system in a rocky soil. The legs of the wind turbine are locked on a cube footing from which a plurality of bars extend and which are anchored to the rock. In the detail shown in the figure, and according to a specific practical embodiment for a wind turbine of a certain height, weight and power, nine bars are included for each of the three footings. The footing has inside connection elements with the leg and the bars extending downwards deepening in the rocky terrain.

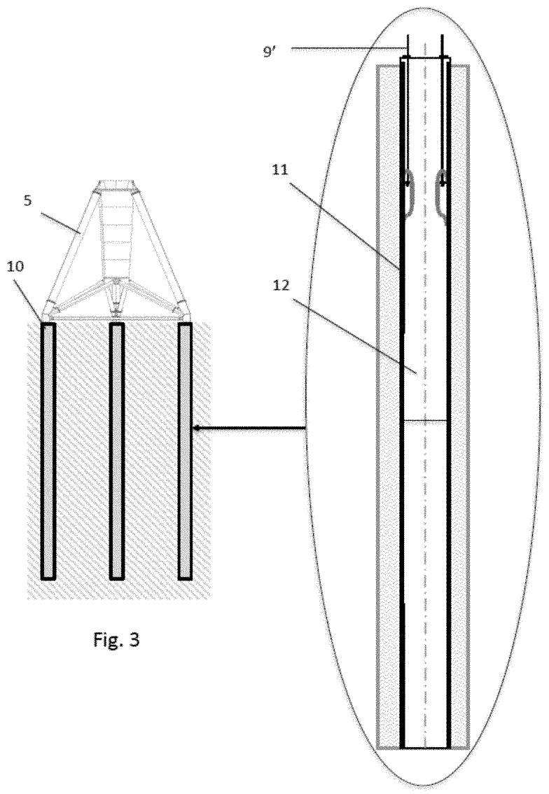

As shown in FIG. 3, the anchoring system in this embodiment is a pile foundation. When the soil is not hard enough to introduce the anchoring bars into the rock, it is proceeded with a pile anchoring system. A deep hole is made, 20 or 30 m deep, which is subsequently filled with metal rods forming the reinforcement and that extend circumferentially along the walls of the hole. The connection elements are placed on the surface with each leg of the wind turbine, which are also attached to the metal reinforcement. Finally, concrete is poured into the hole and left to set.

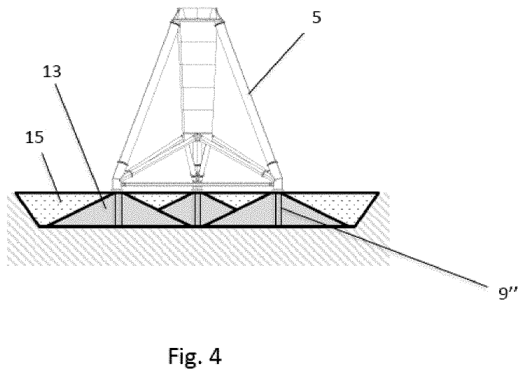

FIG. 4 shows the type of anchoring system used in competent non-rocky soils. In this type of terrain, the conventional gravitational foundation is used, that is, the stability of the foundation is given by the dead weight of the conical footing and the weight of the structure that it supports on top. The footing includes inside connection elements with its corresponding leg. The footing is formed by a structure of metal bars arranged in a conical shape (not shown in the figure) on which concrete is poured and left to set.

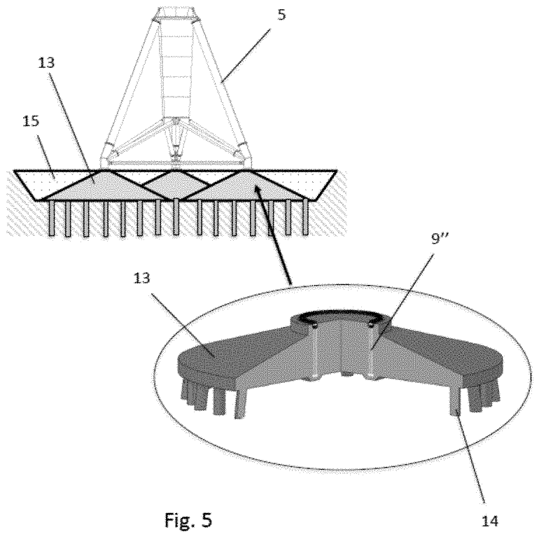

FIG. 5 shows the type of anchoring system used in clayey or swampy soils. In this type of terrain, the gravitational foundation is used where, to give the foundation greater consistency, a plurality of small piles extend from the base of the footing deepening in the terrain and bringing stability to the ensemble. On the three footings which support the wind turbine gravel is poured to smooth the ground.

1- Novel wind turbine and anchoring system thereof, of the type of wind turbine that supports a tubular tower, a nacelle, a rotor and its blades, characterized in that the tower ends in three legs and each of said legs is anchored on rocky soil with an anchored-in-rock foundation, it is anchored on conventional soil with a pile foundation, it is anchored in a competent non-rocky soil with a gravitational foundation and it is anchored on clayey or swampy soil with a gravitational foundation reinforced with piles.

2- Novel wind turbine according to claim 1, wherein the three legs are widely separated from each other, in a ratio between diameter and spacing between legs of one to twenty.

3- Novel wind turbine according to claim 1, wherein the anchored-in-rock foundation has a cube footing for each leg, connection elements between the footing and the leg and a plurality of bars extending downwardly from the footing.

4- Novel wind turbine according to claim 1, where the pile foundation is made with piles of great length reinforced with metal and filled with concrete, it also has connection elements protruding from the surface of the pile.

5- Novel wind turbine according to claim 1, wherein the gravitational foundation is made with a conical footing that includes inside connection elements with the leg.

6- Novel wind turbine according to claim 1, wherein the gravitational foundation is made with a conical footing that includes inside connection elements with the leg and from whose base a plurality of small piles that go deep into the ground extend.
